(19) United States
(12) Patent Application Publication
(10) Pub. No.: US 2008/0188582 A1
(43) Pub. Date: Aug. 7, 2008

(54) Method For Producing Polyurethane And Polyisocyanurate Rigid Foam

(75) Inventors: Pit Lehmann, Osnabruck (DE); Peter von Malotki, Lemforde (DE); Rainer Hensiek, Melle (DE); Lars Schon, Nordhorn (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafem (DE)

(21) Appl. No.: 11/911,544

(22) PCT Filed: Apr. 11, 2006
(86) PCT No.: PCT/EP06/61506

§ 371 Date: Oct. 15, 2007

(30) Foreign Application Priority Data
Apr. 14, 2005 (DE) 102005017363.2

(51) Int. Cl. C08G 18/10

(52) U.S. Cl. 521/172

(57) ABSTRACT

The invention relates to a process for producing rigid polyurethane and polyisocyanurate foams by reacting polyisocyanates a) with compounds having at least two hydrogen atoms which are reactive toward isocyanate groups b) in the presence of blowing agents c), wherein prepolymers which comprise isocyanate groups and have an NCO content in the range from 25 to 31% by weight, based on the weight of the prepolymer, and are prepared by reacting ai) mixtures of monomeric and polymeric diphenylmethane diisocyanate with at least one compound having more than one hydrogen atom which is reactive toward isocyanate groups aii) are used as polyisocyanates a) and the compounds having at least two hydrogen atoms which are reactive toward isocyanate groups b) comprise at least one polyester alcohol bi) which comprises at least one starting component which is hydrophobic.

The invention relates to a process for producing rigid polyurethane and polyisocyanurate foams by reacting polyisocyanates with compounds having at least two hydrogen atoms which are reactive toward isocyanate groups.

Rigid polyurethane and polyisocyanurate foams have been known for a long time and are widely used in industry. An important field of application of the rigid polyurethane and polyisocyanurate foams is composite elements.

The production of composite elements comprising, in particular, metallic covering layers and a core of foams based on isocyanate, usually polyurethane (PUR) or polyisocyanurate (PIR) foams, frequently also referred to as sandwich elements, on continuously operating double belt units is at present practiced on a large scale. Apart from sandwich elements for coolrooms insulation, elements having colored covering layers for producing outer walls of a wide variety of buildings is becoming evermore important. Covering layers used include not only coated steel sheets but also stainless steel, copper or aluminum sheets. Particularly in the case of the outer wall elements, the adhesion between foam and the covering layer plays a critical role. If the color is dark, the insulated outer covering layer can easily heat up to temperatures of about 80° C. If the foam does not adhere sufficiently well to the covering layer, bumps caused by detachment of the foam from the metal sheet form on the surface and these can make the outer wall unattractive in appearance and also have an adverse effect on the statics of the construction. Such bumps can also be caused by flaws in the foam on the back of the metal sheet. Typical flaws in the foam are, for example, voids which can be caused, for example, by contamination on the back of the metal sheet. To eliminate these problems, bonding coatings are already being applied in coil production. However, for process reasons, additives such as leveling agents, hydrophobicizing agents, deaerators and the like are comprised in the bonding coatings. Some of these additives have a considerable adverse effect on the polyurethane foaming process. In addition, interactions between the face coating and the reverse side coating in the steel coil occur. The substances which are in this way additionally transferred to the reverse side likewise often have an adverse effect on the PUR foaming process and lead to undesirable effects such as voids in the sandwich element. The known corona treatment of the covering layers is in many cases also not sufficient to eliminate these adverse effects. Furthermore, it is possible for the temperature of the double belt not to be optimally matched to the respective system. This applies, in particular, in production start-ups when a steady state has not yet been reached. This can likewise have an adverse effect on the foaming process and the adhesion of the foam to the metallic covering layers.

It was therefore an object of the present invention to provide a polyurethane or polyisocyanurate system which ensures a constantly high quality of the sandwich elements produced even in the case of fluctuating external influences and production conditions. In particular, good adhesion of the foam to the covering layers, even over a prolonged period, should be ensured, flaws in the foam at the back of the metal sheet should be minimized and a very high conversion of the isocyanate groups should be achieved.

This object has surprisingly been able to be achieved by using prepolymers comprising isocyanate groups as polyisocyanates and the compounds having two hydrogens which are reactive toward isocyanate groups comprising at least one polyester alcohol which has been prepared using at least one hydrophobic starting component.

The use of isocyanate prepolymers for producing rigid polyurethane and polyisocyanurate foams is known. U.S. Pat. No. 5,164,422 describes the use of isocyanate prepolymers together with R11 as blowing agent for improving the insulation properties of the foams. EP 320134 describes the use of isocyanate prepolymers together with R11 as blowing agent for improving the compatibility of A component and B component. Likewise, improved processing properties are indicated in U.S. Pat. No. 5,254,600 as a result of the use of isocyanate prepolymers. An improvement in the thermal conductivity of the rigid foams as a result of the use of isocyanate prepolymers has been indicated in EP 394736. JP 2000-264945 describes sandwich elements having good surfaces produced using isocyanate prepolymers. WO 240566 describes the use of isocyanate prepolymers for improving the flame-retardant properties and the mechanics of rigid polyurethane and polyisocyanurate foam.

However, none of the documents mentioned describes or even suggests that the object of the present invention can be achieved by the use of prepolymers having the properties claimed by us in combination with the use of the polyester alcohols bi).

The invention accordingly provides a process for producing rigid polyurethane and polyisocyanurate foams by reacting polyisocyanates a) with compounds having at least two hydrogen atoms which are reactive toward isocyanate groups b) in the presence of blowing agents c), wherein prepolymers which comprise isocyanate groups, are based on monomeric diphenylmethane diisocyanate (MMDI) and polymeric diphenylmethane diisocyanate (PMDI) and have an NCO content in the range from 25 to 31% by weight, preferably 26-30% by weight, particularly preferably 28-29% by weight, based on the weight of the prepolymer, and are prepared by reacting ai) mixtures of monomeric and polymeric diphenylmethane diisocyanate with aii) at least one compound having more than one hydrogen atom which is reactive toward isocyanate groups are used as polyisocyanates a) and the compounds having at least two hydrogen atoms which are reactive toward isocyanate groups b) comprise at least one polyester alcohol bi) which has been prepared using at least one starting component which is hydrophobic.

As a result of the NCO content according to the invention, improvements in the processing properties of this system, for example a reduced susceptibility to flaws in the foam at the back of the metal sheet and improved adhesion, are achieved and, in the case of the production of rigid polyisocyanurate foams, sufficient PIR structures to achieve excellent flame resistance are still formed. If the NCO content of the prepolymers is reduced to below the range indicated, there are no longer sufficient isocyanate groups available for the PIR reaction and the flame-retardant properties of the foam deteriorate. Furthermore, the viscosity of the prepolymer increases greatly at NCO contents of less than 26% by weight, so that the processability of this system is impaired.

The preparation of the prepolymers used as polyisocyanates a) is carried out in a customary fashion by reacting an excess of an isocyanate component ai) with a polyol component aii), with the NCO content of the prepolymers being 25-31% by weight, preferably 26-30% by weight, particularly preferably 28-29% by weight.

As isocyanate component ai) for the preparation of the prepolymers, use is made of monomeric MDI or mixtures of monomeric and polymeric MDI. Such mixtures are also referred to as crude MDI. These mixtures preferably have an NCO content of 29-33% by weight and a content of 2-ring MDI of 41±5% by weight, based on the weight of the PMDI.

As monomeric MDI, it is possible to use 4,4′-MDI, 2,4′-MDI and 2,2′-MDI and also any mixtures of the isomers mentioned. It is also possible to modify the monomeric MDI by incorporation of functional groups. This can serve to liquefy the monomeric MDI, but the properties of the MDI can also be altered in a targeted manner. Functional groups which can be incorporated into the MDI are, for example, allophanate, uretdione or isocyanurate groups. Furthermore, TDI, HDI, NDI and IPDI can be used as isocyanates.

For reasons of processability on the double belt, the viscosity of the prepolymer at 25° C. should be in the range 100-3 000 mPas, preferably 200-1 500 mPas, particularly preferably 300-1 200 mPas. Furthermore, the prepolymer should have a content of monomeric MDI of from 28 to 38% by weight, preferably 28-29% by weight, based on the weight of the prepolymer.

As compounds having at least two hydrogen atoms which are reactive toward isocyanate groups aii) for the preparation of the prepolymers a) comprising isocyanate groups, use is made, in particular, of polyfunctional alcohols. Preference is given to using polyether alcohols and/or polyester alcohols. In particular, 1.5 to 3-functional, particularly preferably 1.5 to 2.5-functional polyether alcohols and/or polyester alcohols are used. If alcohols having higher functionalities were to be used, the viscosity of the prepolymers would increase too much.

The polyester alcohols used as component aii) preferably have a hydroxyl number in the range from 50 to 400 mg KOH/g, particularly preferably from 100 to 300 mg KOH/g and in particular from 150 to 250 mg KOH/g.

The polyester alcohols aii) are usually prepared in a customary way by reacting polyfunctional alcohols with polyfunctional carboxylic acids or carboxylic acid derivatives, in particular anhydrides. Alcohols used are usually 2- to 3-functional alcohols, for example ethylene glycol, diethylene glycol, propylene glycol, dipropylene glycol, glycerol, trimethylolpropane and/or butanediol. As carboxylic acids, preference is given to using adipic acid, phthalic acid and/or phthalic anhydride.

The polyether alcohols used as component aii) preferably have a hydroxyl number in the range from 50 to 300 mg KOH/g, in particular from 80 to 250 mg KOH/g.

The polyether alcohols ail) are preferably prepared by addition of alkylene oxides onto 2- and/or 3-functional alcohols having a molecular weight of from 62 to 400. Alkylene oxides used are usually ethylene oxide and/or propylene oxide. As alcohols, it is possible to use, for example, ethylene glycol, diethylene glycol, propylene glycol, glycerol or any mixtures of these alcohols. The addition of the alkylene oxides onto the starter substances is carried out in a customary way, usually using basic catalysts.

In a preferred embodiment of the process of the invention, hydrophobic starting materials are additionally used in the preparation of the polyester alcohols aii). The hydrophobic substances are water-insoluble substances which comprise a nonpolar organic radical and also have at least one reactive group from the group consisting of hydroxyl, carboxylic acid, carboxylic ester and mixtures thereof. The equivalent weight of the hydrophobic materials is in the range from 130 to 1 000. It is possible to use, for example, fatty acids such as stearic acid, oleic acid, palmitic acid, lauric acid or linoleic acid and also fats and oils such as castor oil, maize oil, sunflower oil, soybean oil, coconut oil, olive oil or tall oil. If hydrophobic starting materials are concomitantly used, they are used in an amount of 1-20 mol %, preferably 4-15 mol %, based on the polyester alcohol.

As compounds having at least two hydrogen atoms which are reactive toward isocyanate groups b) for the preparation of the polyurethanes and/or polyisocyanurates, preference is given to using alcohols, in particular polyether alcohols and/or polyester alcohols. The compounds having at least two hydrogen atoms which are reactive toward isocyanate groups b) comprise at least one polyester alcohol bi) which has been prepared using hydrophobic starting materials. These polyester alcohols have a structure corresponding to that of the hydrophobic polyester alcohols ail) used for preparing the prepolymers comprising isocyanate groups. The polyester alcohols ail) and bi) can be different or identical. In a preferred embodiment, the polyester alcohols aii) and bi) are identical.

The polyester alcohol bi) can be used as sole compound having at least two hydrogen atoms which are reactive toward isocyanate groups. In a further embodiment of the process of the invention, further compounds having at least two hydrogen atoms which are reactive toward isocyanate groups are used in addition to the polyester alcohol bi).

The polyols used in combination with the polyester alcohols bi) can be polyether alcohols bii) and/or polyester alcohols biii).

The polyether alcohols bii) are preferably ones having a functionality of from 2 to 3 and a hydroxyl number in the range from 50 to 300 mg KOH/g, as are used for preparing the prepolymers and have been described above.

The polyester alcohols biii) are preferably 1.5- to 3-, particularly preferably 1.5- to 2.5-functional polyester alcohols having a hydroxyl number in the range from 50 to 400 mg KOH/g, as can also be used for the preparation of the prepolymers and are described above. The polyester alcohols bil) are prepared without using a hydrophobic starting component.

In a particular embodiment, both the polyester alcohols aii) used for preparing the prepolymers and the polyester alcohols bi) used in the component b) are free of terephthalic acid.

The proportions of the polyols bi), bii) and biii) are preferably bi) 20-90% by weight, bii) 5-30% by weight, biii) 0-90% by weight, and particularly preferably bi) 20-90% by weight, bii) 5-30% by weight and biii) 5-90% by weight, with the sum of bi), bii) and biii) being 100.

In addition to the above-described polyether alcohols or in place of the above-described polyether alcohols, it is also possible to use polyether alcohols as are customarily employed for producing rigid polyurethane foams as polyether alcohols bii). These are polyether alcohols which have a functionality of at least 2-6 and a hydroxyl number of greater than 250 mg KOH/g and, like the polyether alcohols used in the component ail), are prepared by known methods, for example by anionic addition of alkylene oxides onto H-functional starter substances in the presence of basic catalysts, in particular alkali metal hydroxides. As alkylene oxides, preference is given to ethylene oxide and propylene oxide. The alkylene oxides can be used individually, alternately in succession or as mixtures.

Possible starter molecules are: water, alkanolamines such as ethanolamine, N-methylamine and N-ethylethanolamine, dialkanolamines such as diethanolamine, N-methyldiethanolamine and N-ethyidiethanolamine and trialkanolamines such as triethanolamine and ammonia, and also toluenediamine and diaminodiphenylmethane.

Preference is given to using polyhydric, in particular dihydric to octahydric, alcohols such as ethanediol, 1,2- and 1,3-propanediol, diethylene glycol, dipropylene glycol, 1,4-butanediol, 1,6-hexanediol, glycerol, pentaerythritol, sorbitol and sucrose, polyhydric phenols such as 4,4′-dihydroxydiphenylmethane and 4,4′-dihydroxy-2,2-diphenylpropane, resols, such as oligomeric condensation products of phenol and formaldehyde and Mannich condensates of phenols, formaldehyde and dialkanolamines and also melamine.

The polyester alcohols biii) can, as described in the discussion of the component ai), be prepared by reacting polyfunctional carboxylic acids with polyfunctional alcohols.

The process of the invention is usually carried out in the presence of blowing agents c) and also catalysts, flame retardants and customary auxiliaries and/or additives. With regard to these compounds, the following details may be provided.

As blowing agent c), it is possible to use water which reacts with isocyanate groups to eliminate carbon dioxide. Furthermore, carboxylic acids, preferably formic acid and/or acetic acid, can be used as chemical blowing agent. In combination with or preferably in the place of water, it is also possible to use physical blowing agents. These are compounds which are inert toward the starting components and are usually liquid at room temperature and vaporize under the conditions of the urethane reaction. The boiling point of these compounds is preferably below 50° C. Possible physical blowing agents also include compounds which are gaseous at room temperature and are introduced into the starting components or dissolved therein under pressure, for example carbon dioxide, low-boiling alkanes and fluoroalkanes.

The physical blowing agents are usually selected from the group consisting of alkanes and cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes such as trichlorofluoromethane (R11), dichlorofluoromethane (141b), 1,1,1,3,3-pentafluorobutane (365 mfc), 1,1,1,3,3-pentafluoropropane (245fa) and 1,1,1,2-tetrafluoroethane (134a). The physical blowing agents mentioned can be used alone or in any combinations with one another. Preference is given to isomers of pentane, in particular cyclopentane and n-pentane, particularly preferably n-pentane.

Preference is also given to using carboxylic acids, preferably formic acid, as chemical blowing agent and hydrogen-comprising fluorocarbons as physical blowing agent.

Preference is also given to water as chemical blowing agent and hydrocarbons, preferably homologues of pentane, particularly preferably n-pentane, as physical blowing agent.

Preference is also given to using carboxylic acids, preferably formic acid, as chemical blowing agent and hydrocarbons, preferably homologues of pentane, particularly preferably n-pentane, as physical blowing agent.

The blowing agents used are preferably free of chlorofluorocarbons (CFCs), preferably free of CFCs and FCs, particularly preferably free of CFCs, FCs and HFCs.

In addition, the polyurethane or polyisocyanurate foams further comprise flame retardants. Preference is given to using bromine-free flame retardants. Particular preference is given to using flame retardants comprising phosphorus atoms, for example trischloroisopropyl phosphate, diethyl ethane phosphonate, triethyl phosphate, diphenyl cresyl phosphate and alkoxylated alkylphosphonic acids such as Exolit OP 560. In a particularly preferred embodiment, exclusively halogen-free flame retardants are used.

Catalysts used are, in particular, compounds which strongly accelerate the reaction of the isocyanate groups with the hydrogen atoms which are reactive toward isocyanate groups. Such catalysts are usually strongly basic amines, e.g. tertiary aliphatic amines, imidazoles, amidines and also alkanolamines, and/or organometallic compounds, in particular those based on tin.

If isocyanurate groups are to be incorporated into the rigid foam, specific catalysts are required. As isocyanurate catalysts, use is usually made of metal carboxylates, in particular potassium formate, potassium acetate and potassium octoate, the equivalent ammonium salts and also solutions thereof.

The catalysts can, depending on requirements, be used alone or in any mixtures with one another.

Auxiliaries and/or additives used are the materials known per se for this purpose, for example surface-active substances, foam stabilizers, cell regulators, fillers, pigments, dyes, hydrolysis inhibitors, antistatics, fungistatic and bacteriostatic agents.

To produce the isocyanate-based rigid foams, the polyisocyanates a) and the compounds having at least two hydrogen atoms which are reactive toward isocyanate groups b) are reacted in such amounts that the isocyanate index is in the range from 100 to 220, preferably from 105 to 180, in the case of polyurethane foams. In the production of polyisocyanurate foams, it is also possible to employ an index of >180, preferably 200-500, more preferably 225-400, particularly preferably 280-400.

The rigid polyurethane and polyisocyanurate foams can be produced batchwise or continuously with the aid of known mixing apparatuses. Mixing of the starting components can be carried out with the aid of known mixing apparatuses.

The rigid PUR foams according to the invention are usually produced by the two-component process. In this process, the compounds having at least two hydrogen atoms which are reactive toward isocyanate groups, the blowing agents, the catalysts and the further auxiliaries and/or additives are mixed to form a polyol component and this is reacted with the polyisocyanates or mixtures of the polyisocyanates and, if appropriate, blowing agents.

The starting components are usually mixed at a temperature of from 15 to 35° C., preferably from 20 to 30° C. The reaction mixture can be mixed by means of high- or low-pressure metering machines.

The rigid foams according to the invention are preferably produced on continuously operating double belt units. Here, the polyol component and isocyanate component are metered, preferably by means of a high-pressure machine, and mixed in a mixing head. Catalysts and/or blowing agents can be metered into the polyol mixture before-hand by means of separate pumps. The reaction mixture is continuously applied to the lower covering layer. The lower covering layer together with the reaction mixture and the upper covering layer run into the double belt. Here, the reaction mixture foams and cures. After leaving the double belt, the continuous stock is cut into the desired sizes. Sandwich elements having metallic covering layers or insulation elements having flexible covering layers can be produced in this way.

The composite elements can also be produced batchwise. The starting components are in this case usually mixed at a temperature of from 15 to 35° C., preferably from 20 to 30° C. The reaction mixture can be introduced into closed supporting tools by means of high- or low-pressure metering machines.

The density of the rigid foams produced by the process of the invention is from 10 to 400 kg/m³, preferably 20-200 kg/m³, in particular from 30 to 100 kg/m³.

The thickness of the composite elements is usually from 5 to 300 mm, preferably from 5 to 250 mm.

Further details regarding the starting materials, blowing agents, catalysts and auxiliaries and/or additives used for carrying out the process of the invention may be found, for example, in the Kunststoffhandbuch, vol 7, “Polyurethane” Cari-Hanser-Veriag Munich, 1st edition, 1966, 2nd edition, 1983 and 3rd edition, 1993.

Under constant processing conditions, an improvement in the adhesion, a reduced susceptibility to flaws in the foam of the back of the metal sheet and a significantly higher conversion of the NCO groups, in particular also in the edge zones of the sandwich elements, were found when using the process of the invention. A very high conversion of the NCO groups is necessary, since incomplete conversion, particularly in the edge zone, results in undercrosslinking of the foam, which can be responsible for local weak points in terms of the mechanics of the foam. The burning behavior and the thermal conductivity of the foam remain unchanged. The process of the invention enables, in the case of fluctuating production conditions, the increase in the susceptibility to flaws in the foam at the back of the metal sheet, the deterioration in the adhesion of the foam to the metallic covering layers and a reduced conversion of the isocyanate groups normally associated therewith to be avoided.

The invention is illustrated by the following examples.

Raw Materials Used
Polyesterol 1 prepared from phthalic anhydride and diethylene glycol, functionnality=2, OHN=250 mg KOH/g
Polyesterol 2 prepared from phthalic anhydride, diethylene glycol, monoethylene glycol and oleic acid, functionality=1.8, OHN=200 mg KOH/g
Polyetherol 1 prepared from propylene glycol and propylene oxide, functionality=2, OHN=100 mg KOH/g
Polyetherol 2 prepared from monoethylene glycol and ethylene oxide, functionnality=2, OHN=200 mg KOH/g
Flame retardant TCPP (trischloroisopropyl phosphate)
Stabilizer Tegostab® B 8443 (Degussa)
Catalyst 1 trimerization catalyst (salt of a carboxylic acid dissolved in polyol)
Catalyst 2 amine-containing PUR catalyst
Blowing agent 1 n-pentane
Blowing agent 2 ZM 99 (water in propylene glycol)
Isocyanate 1 monomeric MDI (Lupranate ME, BASF AG)
Isocyanate 2 polymeric MDI (Lupranat®M 20W or Lupranat® M 20S, BASF AG)
Isocyanate 3 polymeric MDI (Lupranat®M 50, BASF AG)
Isocyanate 4 polymeric MDI (Lupranat®M 70R, BASF AG)
Isocyanate 5 polymeric MDI (Lupranat®M 200R, BASF AG)

Preparation of the Prepolymers

### EXAMPLE 1

100 parts of isocyanate 2 were placed in a round-bottom flask and heated to 60° C. Under nitrogen, 11.7 parts of polyesterol 2 were added and the mixture was subsequently stirred at 80° C. for 2 hours. The prepolymer (number 1) was cooled and the viscosity and the NCO content were determined.

The prepolymer had an NCO content of 26.3% by weight and a viscosity at 25° C. of 1 780 mPas.

### EXAMPLE 2

100 parts of isocyanate 2 were placed in a round-bottom flask and heated to 60° C. Under nitrogen, 8 parts of polyesterol 2 were added and the mixture was subsequently stirred at 80° C. for 2 hours. The prepolymer (number 2) was cooled and the viscosity, the NCO content and the ring distribution were determined.

The prepolymer had an NCO content of 28.2% by weight, a viscosity at 25° C. of 910 mPas and a content of 2-ring MDI of 34.6% by weight.

### EXAMPLE 3

100 parts of isocyanate 2 were placed in a round-bottom flask and heated to 60° C. Under nitrogen, 4.5 parts of polyesterol 2 and 4.5 parts of polyetherol 1 were added and the mixture was subsequently stirred at 80° C. for 2 hours. The prepolymer (number 9) was cooled and the viscosity and the NCO content were determined.

The prepolymer had an NCO content of 27.8% by weight and a viscosity at 25° C. of 860 mPas and a content of 2-ring MDI of 33.1% by weight.

All further prepolymers were prepared by the same method. The amount of polyol component was varied according to the desired target NCO content.

TABLE 1
Constituents of the prepolymers and analytical data
(n.d. = not determined)

| | | | | | Two-ring |
|---|---|---|---|---|---|
| | | | | Viscosity | content |
| Prepolymer | | | NCO | [25° C., | [% by |
| No. | Iso comp. | Polyol comp. | [%] | mPas] | weight] |
| 1 | Isocyanate 2 | Polyesterol 2 | 26.3 | 1780 | n.d. |
| 2 | Isocyanate 2 | Polyesterol 2 | 28.2 | 910 | 34.6 |
| 3 | Isocyanate 2 | Polyesterol 2 | 29.4 | 540 | n.d. |
| 4 | Isocyanate 1 | Polyesterol 2 | 27.5 | Solid, (20 | 80.4 |
| | | | | at 75° C.) | |
| 5 | Isocyanate 4 | Polyesterol 2 | 27.5 | 3400 | 24.3 |
| 6 | Isocyanate 5 | Polyesterol 2 | 27.4 | 14100 | 17.2 |
| 7 | Isocyanate 2 | Polyetherol 1 | 28.0 | 620 | 35.6 |
| 8 | Isocyanate 2 | Polyetherol 2 | 28.2 | 660 | 35.1 |
| 9 | Isocyanate 2 | Polyesterol | 27.8 | 860 | 33.1 |
| | | 2 + | | | |
| | | Polyetherol 1 | | | |

The viscosity of the prepolymers was determined using a Haake VT 500 rotational viscosimeter at 25° C. immediately after the end of the prepolymer synthesis (reported values). The NCO content of the prepolymers was likewise determined immediately after the end of the synthesis, as follows: the prepolymer was dissolved in N-methylpyrrolidone (NMP) and admixed with an excess of di-n-hexylamine. The excess amine was backtitrated using hydrochloric acid.

The two-ring content of the prepolymers was analyzed by means of gel chromatography (refractive index analysis). The analytical data obtained were calibrated by means of monomeric MDI and converted into percent by weight.

Production of Rigid Polyurethane and Polyisocyanurate Foams

A polyol component was prepared by mixing the polyols, flame retardants and stabilizers. The polyol component and the prepolymer were foamed with addition of catalyst and blowing agent in such a way that the fiber time was in each case 45 seconds and the foam density was in each case 45 g/l.

To measure the adhesion between the foam and covering layer, test specimens having the dimensions 200×200×80 mm and two metallic covering layers were produced in a heatable metal mold at 50° C. in the laboratory, After curing of the system, test specimens having the dimensions 100×100×80 mm were sawn from the middle and the adhesion of the foam to the covering layers was determined in accordance with DIN EN ISO 527-1/DIN 53292.

The NCO conversion was determined by means of IR spectroscopy. Here, a test specimen was taken by means of a reproducible method from the middle and from the edge of the sandwich elements produced and was measured by means of ATR-FTIR spectroscopy (Golden Gate arrangement). The absorbance (A) of the NCO band at 2 270 cm⁻¹ was divided by the absorbance of an aromatic reference band at 1 600 cm⁻¹: ANCO=A_{2270 cm-1}/A_{1600 cm-1}. The conversion was calculated from the decrease in the absorbance ratio of the fully reacted system divided by an unreacted starting system (no catalyst):

Conversion=[1−(A_{NCOfully reacted}/A_{NCOunreacted})]*100.

The sandwich elements were produced (thickness=80 mm) on a double belt (60° C.) at a belt velocity of 6 m/min. The frequency of the flaws in the foam at the back of the metal sheet were determined by an optical method after pulling off the covering layer from the lower side of the element. As comparative examples, the following were employed: i) double belt temperature of 55° C. and ii) use of contaminated metal sheets (metal sheets comprised an increased amount of contamination on the reverse side—detected using TOF-SIMS spectroscopy).

TABLE 2
Foamed Lupranat ® M 50 (comparative example 1) and prepolymer systems under constant experimental
conditions. The sandwich elements for assessing the flaws in the foam at the back of the metal sheet were
produced using a double belt temperature of 60° C. and a constant metal sheet quality. The conductivity
(21.4 mW/mK at 23° C. in accordance with DIN 52612) of the systems 1-9 was identical.

| | 1 | 2 | 3 | 4 | 5 | 6 | 7 | 8 | 9 |
|---|---|---|---|---|---|---|---|---|---|
| Polyesterol 1 | 48 | 48 | 48 | 48 | 48 | 48 | 48 | 48 | 68 |
| Polyesterol 2 | 20 | 20 | 20 | 20 | 20 | 20 | 20 | 20 | — |
| Polyetherol 2 | 10 | 10 | 10 | 10 | 10 | 10 | 10 | 10 | 10 |
| Flame retardant | 20 | 20 | 20 | 20 | 20 | 20 | 20 | 20 | 20 |
| Stabilizer | 2 | 2 | 2 | 2 | 2 | 2 | 2 | 2 | 2 |
| Catalyst 1 | 1.5 | 1.5 | 1.5 | 1.5 | 1.5 | 1.5 | 1.5 | 1.5 | 1.5 |
| Catalyst 2 | 1.5 | 1.5 | 1.5 | 1.5 | 1.5 | 1.5 | 1.5 | 1.5 | 1.5 |
| Blowing agent 1 | 13 | 14 | 14 | 14 | 14 | 14 | 14 | 14 | 14 |
| Blowing agent 2 | 0.7 | 0.7 | 0.7 | 0.7 | 0.7 | 0.7 | 0.7 | 0.7 | 0.7 |
| Isocyanate 3 | 190 | | | | | | | | |
| Prepolymer 2 | | 210 | | | | | | | 210 |
| Prepolymer 4 | | | 210 | | | | | | |
| Prepolymer 5 | | | | 210 | | | | | |
| Prepolymer 6 | | | | | 210 | | | | |
| Prepolymer 7 | | | | | | 210 | | | |
| Prepolymer 8 | | | | | | | 210 | | |
| Prepolymer 9 | | | | | | | | 210 | |
| Index | 340 | 340 | 330 | 330 | 330 | 335 | 340 | 333 | 330 |
| Adhesion | 0.11 | 0.15 | 0.14 | 0.18 | 0.16 | 0.16 | 0.15 | 0.16 | 0.12 |
| [N/mm²] | | | | | | | | | |
| Number of | moderate | small | small | small | small | small | small | small | moderate |
| flaws in the | | | | | | | | | |
| back of the | | | | | | | | | |
| metal sheet | | | | | | | | | |
| NCO conversion | 91% | 94% | 93% | 95% | 93% | 94% | 94% | 95% | 93% |
| (middle) | | | | | | | | | |
| NCO conversion | 85% | 89% | 88% | 87% | 89% | 88% | 88% | 89% | 87% |
| (edge) | | | | | | | | | |

TABLE 3
Examples of the influence of processing conditions which are not constant:
double belt temperature of 55° C. (examples 1 and 2) and use of
contaminated metal sheets (examples 3 and 4).

| | 10 | 11 | 12 | 13 |
|---|---|---|---|---|
| Polyesterol 1 | 48 | 48 | 48 | 48 |
| Polyesterol 2 | 20 | 20 | 20 | 20 |
| Polyetherol 2 | 10 | 10 | 10 | 10 |
| Flame retardant | 20 | 20 | 20 | 20 |
| Stabilizer | 2 | 2 | 2 | 2 |
| Catalyst 1 | 1.5 | 1.5 | 1.5 | 1.5 |
| Catalyst 2 | 1.5 | 1.5 | 1.5 | 1.5 |
| Blowing agent 1 | 13 | 14 | 13 | 14 |
| Blowing agent 2 | 0.7 | 0.7 | 0.7 | 0.7 |
| Isocyanate 3 | 190 | | 190 | |
| Prepolymer 2 | | 210 | | 210 |
| Index | 340 | 340 | 340 | 340 |
| Adhesion | 0.08 | 0.12 | 0.07 | 0.1 |
| [N/mm²] | | | | |
| Number of flaws | large | moderate | large | moderate |
| in the foam at the | | | | |
| back of the metal | | | | |
| sheet | | | | |

1. A process for producing rigid polyurethane and polyisocyanurate foams by reacting polyisocyanates a) with compounds having at least two hydrogen atoms which are reactive toward isocyanate groups b) in the presence of blowing agents c), wherein prepolymers which comprise isocyanate groups and have an NCO content in the range from 25 to 31% by weight, based on the weight of the prepolymer, and are prepared by reacting ai) mixtures of monomeric and polymeric diphenylmethane diisocyanate with at least one compound having more than one hydrogen atom which is reactive toward isocyanate groups aii) are used as polyisocyanates a) and the compounds having at least two hydrogen atoms which are reactive toward isocyanate groups b) comprise at least one polyester alcohol bi) which comprises at least one starting component which is hydrophobic.

2. The process according to claim 1, wherein the prepolymers comprising isocyanate groups have an NCO content in the range 26-30% by weight, based on the weight of the prepolymer.

3. The process according to claim 1, wherein the prepolymers comprising isocyanate groups have a content of 2-ring diphenylmethane diisocyanate of from 28 to 38% by weight, based on the weight on the prepolymer, preferably from 30 to 36% by weight.

4. The process according to claim 1, wherein the mixtures of monomeric and polymeric diphenylmethane diisocyanate ai) have an NCO content of from 29 to 33% by weight.

5. The process according to claim 1, wherein the mixtures of monomeric and polymeric diphenylmethane diisocyanate ai) have a proportion of monomeric 2-ring MDI of 41±5% by weight, based on the weight of the mixture.

6. The process according to claim 1, wherein the at least 2-functional polyols for preparing the prepolymers comprising isocyanate groups are polyether alcohols aii).

7. The process according to claim 1, wherein the polyether alcohols aii) have a hydroxyl number of from 50 to 300 mg KOH/g.

8. The process according to claim 1, wherein the at least 2-functional polyols aii) for preparing the prepolymers comprising isocyanate groups are polyester alcohols.

9. The process according to claim 1, wherein the polyester alcohols aii) have a hydroxyl number of from 50 to 400 mg KOH/g.

10. The process according to claim 1, wherein the polyester alcohols aii) have been prepared using at least one hydrophobic starting component.

11. The process according to claim 1, wherein the polyols aii) for preparing the prepolymers comprising isocyanate groups are mixtures of polyether alcohols and polyester alcohols.

12. The process according to claim 1, wherein the polyester alcohol bi) has a hydroxyl number of from 100 to 300 mg KOH/g.

13. The process according to claim 1, wherein the hydrophobic starting component for preparing the polyester alcohol bi) is oleic acid.

14. The process according to claim 1, wherein the polyester alcohol bi) is used in a mixture with at least one polyether alcohol bii) and/or at least one polyester alcohol biii), with the polyester alcohol biii) having been prepared without use of a hydrophobic starting component.

15. The process according to claim 14, wherein the polyol bi) is used in an amount of 20-90% by weight, the polyol bii) is used in an amount of 5-30% by weight and biii) is used in an amount of 0-90% by weight in the component b), with the sum of bi), bii) and biii) being 100.

16. The process according to claim 1, wherein physical blowing agents and optionally chemical blowing agents are used as blowing agents.

17. The process according to claim 16, wherein water is used as chemical blowing agent and hydrogen-comprising fluorocarbons are used as physical blowing agent.

18. The process according to claim 16, wherein carboxylic acids, preferably formic acid, are used as chemical blowing agent and hydrogen-comprising fluorocarbons are used as physical blowing agent.

19. The process according to claim 16, wherein water is used as chemical blowing agent and hydrocarbons, preferably homologues of pentane, particularly preferably in n-pentane, are used as physical blowing agent.

20. The process according to claim 16, wherein carboxylic acids, preferably formic acid, are used as chemical blowing agent and hydrocarbons, preferably homologues of pentane, particularly preferably n-pentane, are used as physical blowing agent.
